(19) United States
(12) Patent Application Publication
(10) Pub. No.: US 2022/0250230 A1
(43) Pub. Date: Aug. 11, 2022

(54) TOOL HAMMER HANDLE WITH PROTECTIVE DEVICE

(71) Applicant: Wenzhou Guoxin Hardware Tools Co., Ltd., Wenzhou (CN)

(72) Inventors: Bangying HUANG, Wenzhou (CN); Yu ZHANG, Wenzhou (CN); Jianxin ZHANG, Wenzhou (CN)

(21) Appl. No.: 17/534,478

(22) Filed: Nov. 24, 2021

(30) Foreign Application Priority Data
Feb. 7, 2021 (CN) 202120357103.9

(51) Int. Cl. B25G 1/10

(52) U.S. Cl. CPC B25G 1/102

(57) ABSTRACT

A tool hammer handle with a protective device is provided and belongs to field of hardware tools. It includes a handle body for connecting a hammer head; a handle protective component arranged on an end of the handle body close to the hammer head. The handle protective component includes a connecting part sleeved on the handle body and a protective plate fixedly connected to the connecting part, the connecting part is barrel-shaped and opened at both ends, the protective plate is a sheet-like structure, and the connecting part is arranged on a side of the handle protective component close to a striking end of the hammer head. The protective plate can prevent the handle body from being damaged to thereby improve service life of the handle body, and significantly improve bending force data and pull-out force test data of the hammer.

### FIELD OF THE DISCLOSURE

The disclosure relates to the field of hardware tools, and more particularly to a tool hammer handle with a protective device.

### BACKGROUND OF THE DISCLOSURE

Tool hammer is a tool that knocks an object to make it move or deform. It is most commonly used to knock nails, straighten or break objects. The tool hammer has various forms. The common form is a handle and a top, a side of the top is flat for knocking, and the other side is a hammer head. The tool hammer is the main striking tool, which is composed of the hammer head and the hammer handle. According to its function, the tool hammer is divided into derusting hammer, fitter's hammer, machinery hammer, claw hammer, testing hammer, Engineer's Cross Pein Hammer, octagonal hammer, German octagonal hammer, etc.

During knocking process of the tool hammer, an outer surface of the hammer handle near an end of the hammer head is easy to be knocked, which is easy to cause damage to the hammer handle. In the long run, the hammer handle will break and reduce the service life of the tool hammer. In view of the above problems, a tool hammer handle with a protective device is proposed.

### SUMMARY OF THE DISCLOSURE

The disclosure provides a tool hammer handle with a protective device, which aims to solve the problem that the hammer handle of the current hammer is easy to be damaged.

The disclosure is realized as follows. Specifically, a tool hammer handle with a protective device may include:

a handle body configured to connect a hammer head; and

a handle protective component arranged on an end of the handle body close to the hammer head and configured to protect the handle body.

The handle protective component may include a connecting part sleeved on the handle body and a protective plate fixedly connected to the connecting part. The connecting part is barrel-shaped opened at both ends, the protective plate is a hard sheet-like structure, and the connecting part is located on a side of the handle protective component close to a striking end of the hammer head.

In an embodiment, a handle sleeve is fixedly connected to an end of the handle body close to the handle protective component, and the handle sleeve and the hammer head clamp the handle protective component on the handle body.

In an embodiment, an end of the handle sleeve close to the handle protective component is provided with a connector, the connector is a groove structure. An end of the handle protective component away from the hammer head is provided with a second fixing part, the second fixing part is a protrusion arranged on the handle protective component, and the second fixing part is fixed into the connector when the handle sleeve is connected to the handle protective component.

In an embodiment, the connector is fixedly connected to the second fixing part.

In an embodiment, another end of the handle protective component close to the hammer head is provided with a first fixing part, the first fixing part includes a plurality of annular protrusions arranged along an axis of the handle body and configured to increase stability of connection between the handle protective component and the hammer head.

In an embodiment, two sides of the first fixing part are provided with fixing members respectively, and each of the fixing member is in a groove-shaped.

In an embodiment, another end of the handle body away from the handle protective component is sleeved with a handle anti-skid sleeve configured to increase anti-skid performance of the tool hammer handle.

In an embodiment, anti-skid grooves are disposed the handle anti-skid sleeve.

In an embodiment, the handle anti-skid sleeve is disposed with anti-skid protrusions.

Compared with the prior art, the embodiments of the disclosure mainly have the following beneficial effects:

the tool hammer handle with the protective device provided by the disclosure is provided with the handle protective component at one end of the handle body close to the hammer head, and the side of the handle protective component close to the striking end of the hammer head is provided with the protective plate. During percussion, if the hammer head slides from the nail, the protective plate can prevent the nail from directly impacting the handle body, thereby preventing the handle body from being damaged, thereby improving the service life of the handle body; and the protective plate can also significantly improve the bending force data and pull-out force test data of the hammer.

### BRIEF DESCRIPTION OF THE DRAWINGS

FIG. 1 is a schematic structural diagram of a tool hammer handle with a protective device provided by the disclosure.

FIG. 2 is a schematic structural diagram of a handle protective component in an embodiment of a tool hammer handle with a protective device provided by the disclosure.

FIG. 3 is a schematic structural diagram of a handle body in a tool hammer handle with a protective device provided by the disclosure.

FIG. 4 is a schematic structural diagram of a handle protective component in another embodiment of a tool hammer handle with a protective device provided by the disclosure.

FIG. 5 is a schematic structural diagram of a combination of a handle protective component and a handle body in still another embodiment of a tool hammer handle with a protective device provided by the disclosure.

### DETAILED DESCRIPTION OF EMBODIMENTS

Unless otherwise stated, all technical and scientific terms used herein have same meanings as those commonly understood by those skilled in the technical field of the disclosure. The terms used in the specification of the disclosure are only for the purpose of describing specific embodiments, and are not intended to limit the disclosure. The terms “including” and “ having” used in the specification, appended claims and the description of accompanying drawings of the disclosure and any variations thereof are intended to cover non-exclusive inclusions. The terms “first”, “second”, etc. in the specification and the claims, or the above-mentioned drawings are used to distinguish different objects, rather than to describe a specific order.

The phase “embodiment” mentioned in the disclosure means that a specific feature, structure or characteristic described in conjunction with the embodiment may be included in at least one embodiment of the disclosure. The phrase appeared in various places in the specification does not necessarily refer to the same embodiment, nor is it an independent or alternative embodiment mutually exclusive with other embodiments. Those skilled in the art explicitly and implicitly understand that the embodiments described herein can be combined with other embodiments.

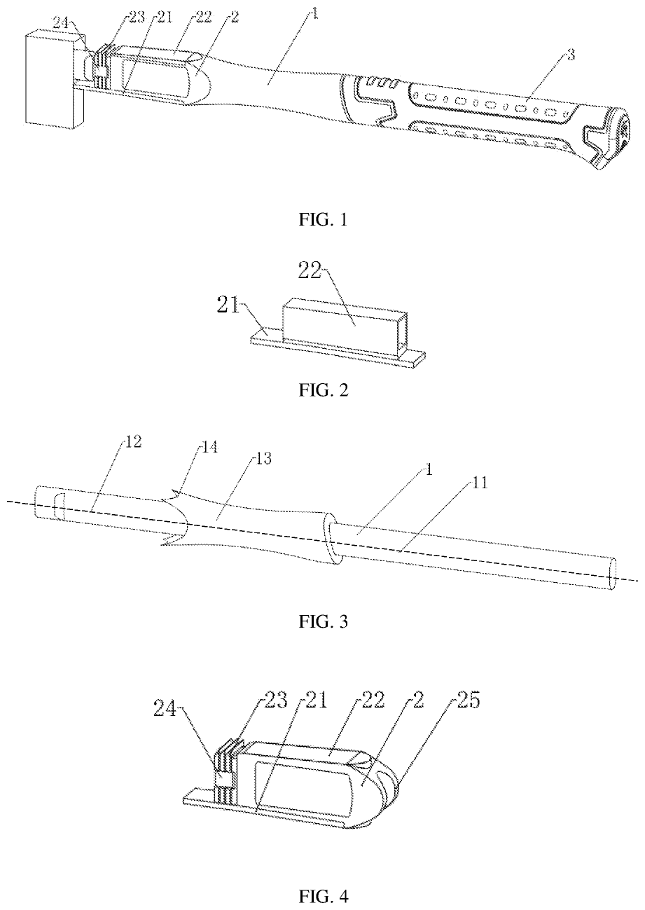

The embodiments of the disclosure provide a tool hammer handle with a protective device, as shown in FIG. 1 and FIG. 2. The tool hammer handle may include:

a handle body 1 configured to connect a hammer head; and

a handle protective component 2 arranged at an end of the handle body 1 close to the hammer head and configured to protect the handle body 1.

The handle protective component 2 may include a connecting part 22 sleeved on the handle body 1 and a protective plate 21 fixedly connected to the connecting part 22. The connecting part 22 is barrel-shaped opened at both ends, the protective plate 21 is a hard sheet-like structure, and the connecting part 22 is located on a side of the handle protective component 2 close to a striking end of the hammer head.

In an illustrated embodiment, the handle protective component 2 is installed on the handle body 1 close to the hammer head, and the hammer head is fixedly connected to the handle body 1. Since the protective plate 21 is arranged on the side of the handle protective component 2 close to the striking end of the hammer head, if the hammer head slips from the nail during percussion, the protective plate 21 can prevent the nail from directly hitting the handle body 1, and can also increase the stress area of the handle body 1, so as to prevent the handle body 1 from being damaged to thereby improve the service life of the handle body 1. At the same time, the protective plate 21 can also significantly improve the bending force data and pull-out force test data of the hammer. As shown in FIG. 3 and FIG. 4, an end of the handle body 1 is provided with a hammer head connecting part 12 for installing the hammer head, the handle protective component 2 is sleeved on the hammer head connecting part 12, and the hammer head presses the handle protective component 2 on the handle body 1.

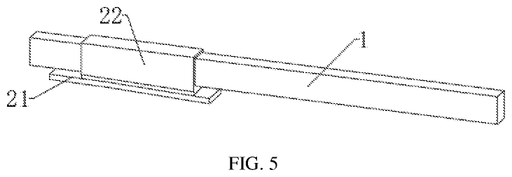

In some illustrated embodiments, as shown in FIG. 5, the connecting part 22 is sleeved on the handle body 1, and the connecting part 22 and the handle body 1 can be fixedly connected by bonding, welding, buckling, clamping and other connection methods. The disclosure does not limit the connection methods between the connecting part 22 and the handle body 1.

In an illustrated embodiment of the disclosure, as shown in FIG. 2, another end of the handle body 1 close to the handle protective component 2 is fixedly connected to a handle sleeve 13, and the handle sleeve 13 and the hammer head clamp the handle protective component 2 on the handle body 1.

As shown in FIG. 3 and FIG. 4, an end of the handle sleeve 13 close to the handle protective component 2 is provided with a connector 14, the connector 14 is a groove structure, an end of the handle protective component 2 away from the hammer head is provided with a second fixing part 25, the second fixing part 25 is a protrusion arranged on the handle protective component 2, and the second fixing part 25 is fixed into the connector 14 when the handle sleeve 13 is connected to the handle protective component 2.

In some illustrated embodiments, the second fixing part 25 and the connector 14 are connected by glue, so as to increase stability of connection between the second fixing part 25 and the connector 14 to thereby prevent the handle protective component 2 from loosening on the handle body 1.

In the illustrated embodiment, the handle body 1 and the handle sleeve 13 can be an integrated structure. For example, when the handle body 1 is a metal structure, the handle sleeve 13 and the handle body 1 are processed by casting.

In some illustrated embodiments, the handle body 1 and the handle sleeve 13 can also be other structures, for example, the handle body 1 is a rod-shaped, and the handle sleeve 13 is barrel-shaped opened at both ends. The handle sleeve 13 is fixedly connected to the handle body 1, for example, the handle sleeve 13 and the handle body 1 are fixedly connected by nails penetrating the handle body 1 and the side of the handle sleeve 13, or the handle body 1 and the handle sleeve 13 are fixedly connected by adhesive or interference fit.

In an illustrated embodiment of the disclosure, another end of the handle protective component 2 close to the hammer head is provided with a first fixing part 23. The first fixing part 23 includes a plurality of annular protrusions arranged along an axis of the handle body 1, which is used to increase the stability of the connection between the handle protective component 2 and the hammer head.

In the illustrated embodiment, when the hammer head is installed on the handle body 1, the first fixing part 23 is connected to the hammer head through interference, and the first fixing part 23 is arranged inside the hammer head so that the fixing block 24 is fixedly connected to the hammer head.

In some illustrated embodiments, a section of the first fixing part 23 is triangular-shaped, so that the first fixing part 23 is easy to be fixed to the inside of the hammer head. At the same time, the edge of the first fixing part 23 can be clamped in the inside of the hammer head to prevent the first fixing part 23 from separating from the hammer head.

In an illustrated embodiment, two sides of the first fixing part 23 are provided with fixing members 24 respectively. Each of the fixing members 24 is groove-shaped. When fixing the hammer head, a wedge-shaped block is inserted into the fixing block 24, which can increase the stability of the connection between the handle protective component 2 and the hammer head.

In an illustrated embodiment of the disclosure, another end of the handle body 1 away from the handle protective component 2 is sleeved with a handle anti-skid sleeve 3, which is used to increase the anti-skid performance of the handle.

In the illustrated embodiment, the handle body 1 is provided with an anti-skid sleeve connecting part 11, and the handle anti-skid sleeve 3 is fixedly connected to the handle body 1 through an interference fit.

In some illustrated embodiments, the handle anti-skid sleeve 3 is barrel-shaped opened at one end, and the handle anti-skid sleeve 3 is a soft shockproof and anti-skid material such as rubber, such as TPR (Thermo Plastic Rubber) or TPE (Thermoplastic Elastomer).

In an illustrated embodiment, anti-skid grooves are disposed on the handle anti-skid sleeve 3for further increasing the anti-skid performance of the handle.

In some illustrated embodiments, the handle anti-skid sleeve 3 is disposed with anti-skid protrusions.

In summary, the disclosure provides a tool hammer handle with a protective device, including:

the handle body 1configured to connect the hammer head; and

the handle protective component 2 arranged at one end of the handle body 1 close to the hammer head and configured to protect the handle body 1.

The handle protective component 2 includes the connecting part 22 sleeved on the handle body 1 and the protective plate 21 fixedly connected to the connecting part 22. The connecting part 22 is a barrel-shaped opened at both ends, the protective plate 21 is a hard sheet-like structure, and the connecting part 22 is located on the side of the handle protective component 2 close to the striking end of the hammer head.

In the illustrated embodiment, the handle protective component 2 is installed on the handle body 1 close to the hammer head, and the hammer head is fixedly connected to the handle body 1. Since the connection part 22 is arranged on the side of the handle protective component 2 close to the striking end of the hammer head, if the hammer head slips from the nail during percussion, the connecting part 22 can prevent the nail from directly hitting the handle body 1, so as to prevent the handle body 1 from being damaged to thereby improve the service life of the handle body 1.

The above embodiments are only used to illustrate technical solutions of the disclosure, but not to limit the protection scope of the disclosure. Apparently, the described embodiments are only some of embodiments of the disclosure, rather than all embodiments of the disclosure. Based on these described embodiments, all other embodiments obtained by those skilled in the art without creative effort fall within the scope of the disclosure. Although the disclosure has been described in detail with reference to the above-mentioned embodiments, those skilled in the art can still combine, add, delete, or make other amendments to the features of the various embodiments of the disclosure according to actual situations without any creative effort, to thereby obtain other different technical solutions without deviating from the inventive concept of the disclosure, and these technical solutions also belong to the protection scope of the disclosure.

What is claimed is:

1. A tool hammer handle with a protective device, comprising:
a handle body, configured to connect a hammer head; and
a handle protective component, arranged on an end of the handle body close to the hammer head and configured to protect the handle body;
wherein the handle protective component comprises a connecting part sleeved on the handle body and a protective plate fixedly connected to the connecting part, the connecting part is barrel-shaped and opened at both ends, the protective plate is a sheet-like structure, and the connecting part is located on a side of the handle protective component close to a striking end of the hammer head.

2. The tool hammer handle with a protective device according to claim 1, wherein a handle sleeve is fixedly connected to an end of the handle body close to the handle protective component, and the handle sleeve and the hammer head clamp the handle protective component on the handle body.

3. The tool hammer handle with protective device according to claim 2, wherein an end of the handle sleeve close to the handle protective component is provided with a connector, the connector is a groove structure, an end of the handle protective component away from the hammer head is provided with a second fixing part, the second fixing part is a protrusion arranged on the handle protective component, and the second fixing part is fixed into the connector when the handle sleeve is connected to the handle protective component.

4. The tool hammer handle with a protective device according to claim 3, wherein the connector is fixedly connected to the second fixing part.

5. The tool hammer handle with a protective device according to claim 1, wherein another end of the handle protective component close to the hammer head is provided with a first fixing part, the first fixing part comprises a plurality of annular protrusions arranged along an axis of the handle body and configured to increase stability of connection between the handle protective component and the hammer head.

6. The tool hammer handle with a protective device according to claim 5, wherein two sides of the first fixing part are provided with fixing members respectively, and each of the fixing members is groove-shaped.

7. The tool hammer handle with a protective device according to claim 1, wherein another end of the handle body away from the handle protective component is sleeved with a handle anti-skid sleeve configured to increase anti-skid performance of the tool hammer handle.

8. The tool hammer handle with a protective device according to claim 7, wherein anti-skid grooves are disposed on the handle anti-skid sleeve.

9. The tool hammer handle with a protective device according to claim 7, wherein the handle anti-skid sleeve is disposed with anti-skid protrusions.
